(19) United States
(12) Patent Application Publication
(10) Pub. No.: US 2008/0016150 A1
(43) Pub. Date: Jan. 17, 2008

(54) System and method for downloading information

(76) Inventor: Wen-Shyen Eric Chen, Taichung (TW)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 11/821,891

(22) Filed: Jun. 26, 2007

Related U.S. Application Data
(60) Provisional application No. 60/817,441, filed on Jun. 29, 2006.

(51) Int. Cl. G06F 15/16

(52) U.S. Cl. 709/203

(57) ABSTRACT

In one example, a method to transmit data to one or more devices is provided. One or more data files are transmitted cyclically via one or more respective channels, such as a radio-frequency channel, a request for at least one desired data file is received from a device, and a message identifying a respective channel associated with the at least one desired data file is transmitted to the device. The at least one desired data file may be transmitted cyclically via at least one selected channel. The at least one desired data file may comprise one or more software applications, such as an operating system. Other systems and methods of assembly and data transmission are also described.

The present application claims priority from U.S. Patent Application No. 60/817,441, which was filed on Jun. 29, 2006, is assigned to the assignee of the present application, and is incorporated by reference herein in its entirety.

### FIELD OF THE INVENTION

This invention relates generally to a system and method for downloading information, such as software, data, or multimedia content. More particularly, this invention relates to a system and method for multicasting software, data and/or multimedia content to multiple devices.

### BACKGROUND OF THE INVENTION

Many techniques have been developed to transmit software or data from a central location to one or more devices. In many instances, the transmission of software or data is limited by issues relating to bandwidth, formatting, etc.

Downloading software or data can be particularly challenging and time-consuming when the software or data must be transmitted to a large number of devices, such as during a process of manufacturing and assembling computers or other electronic devices. In many existing computer manufacturing/assembly facilities, software such as operating systems are installed in the memory of an assembled computer by connecting the computer by cable to a server computer The server then transmits the software to the computer. After the software is stored in the computer's memory, the computer is disconnected from the server. An operating system and other software are installed on each assembled computer in this manner.

In some manufacturing facilities, more than one assembled computer can be connected to a server computer through a single cable connection, to receive software and/or data simultaneously. For example, in some facilities up to sixty computers may be connected simultaneously to a server computer. However, the number of computers that can be connected via a single cable connection remains limited relative to the capacity of some manufacturing/assembly facilities (some facilities can produce thousands of assembled products per day). While additional server computers may be added, this solution can be costly. In addition, in many cases if a transmission problem occurs and prevents a particular computer from receiving data via a cable connection, transmissions over that connection must be halted until the problem is resolved, delaying the download procedure for all computers using the respective connection. Also, the need to link each assembled computer physically to a server computer can be time-consuming and labor-intensive. This approach is often further limited by the batch nature of the procedure—all of the devices connected to a single server must be connected and prepared to receive software and/or data at the moment the procedure begins. These constraints significantly limit the number of assembled computers that can be processed simultaneously. In facilities capable of producing thousands of assembled computers per day, constraints such as these can represent an undesirable “bottleneck” within the assembly process. In a competitive industry, such as the manufacture and assembly of computers and other electronic devices, any such constraint that tends to increase the time and/or resources required to produce a finished product is undesirable.

### SUMMARY

In accordance with one embodiment of the invention, a system comprising at least one computer transmits information cyclically, from the beginning to the end, via selected multicast channels to one or more devices. As used herein, the term “multicast channel” is a communication channel in any medium that may be used to transmit information to multiple devices, and may comprise, without limitation, communication channels used in wireless transmissions, cable transmissions, transmissions via the Internet, transmissions via telephone lines, etc. As used herein, the term “information” may comprise, without limitation, one or more software applications, data, multimedia content, etc.

In one example, the system may be implemented in a facility used to manufacture devices, such as laptop computers. The computer may comprise at least one server computer, for example, which transmits selected software applications via respective wireless channels. The devices may comprise laptop computers that are assembled and need to be loaded with software. Software applications may also be downloaded onto other types of devices, such as personal computers. The devices are placed at an appropriate distance from the server computer to allow the devices and the computer to communicate wirelessly. When placed on an assembly line within an appropriate range, a respective device obtains a copy of a selected one (or more) of the software applications from the server computer via a wireless channel. In one example, the device submits to the server computer a request for a selected software application. When the request is received by the server computer, the computer identifies the device, and identifies a software application responsive to the request. The computer may select a version of the software application suitable to the requesting device, from among multiple versions of the software application. The computer also determines a wireless channel on which the identified software application is being transmitted, and transmits to the device a message identifying the channel. The requesting device receives the message and, in response, tunes to the wireless channel and downloads the desired software application. The software is cyclically, repeatedly transmitted on the wireless channel so that each device can start receiving the software at any point, and continue to receive the software until the entire package is delivered.

In other examples of embodiments of the invention, information may be multicast to devices via other media, such as through cable connections, via the Internet, via an Ethernet Switch Based network, etc. In one alternative example, methods and systems described herein may be used in a manufacturing/assembly facility to transmit information, including software such as an operating system, to assembled devices via cable connections. In another alternative example, methods described herein may be used to distribute information, including media content, to multiple devices over the Internet. The number of channels that can be used, and therefore the number of different software, data, or multimedia applications (or versions thereof) that may be multicast simultaneously, is limited by a variety of factors known in the art including characteristics of the medium used.

Accordingly, in one example, a method to transmit data to one or more devices is provided. One or more data files are transmitted cyclically via one or more respective channels, a request for at least one desired data file is received from a device, and a message identifying a respective channel associated with the at least one desired data file is transmitted to the device. The at least one desired data file may be transmitted cyclically via at least one selected channel. The at least one desired data file may comprise one or more software applications. The one or more software applications may comprise at least a first version of a selected software application, the first version being suitable for a first type of device, and a second version of the software application, the second version being suitable for a second type of device. The one or more software applications may comprise at least one operating system.

The at least one selected channel may comprise at least one radio-frequency channel. The device may comprise at least one device chosen from a group consisting of: a personal computer, a laptop computer, a Blackberry device, a cell phone, a personal digital assistant, and a game console. The request may comprise an identifier of the device.

At least two partitions may be defined within the at least one desired data file. A second data file may be generated comprising the at least two partitions and address information indicating at least one memory address associated with each respective partition. The second data file is compressed and converted into a set of data packets. The set of data packets is transmitted cyclically via the at least one selected channel.

The second data file may be compressed. The message may further comprise second information indicating a number of data packets associated with the set of data packets. The one or more data files may comprise video data. The one or more respective channels may comprise at least one channel chosen from a group consisting of: a radio-frequency channel, a cable network channel, and an Internet channel.

The method may additionally comprise transmitting a second data file cyclically via a second channel different from the at least one selected channel. In one example, a second request for the second data file is received from a second device, and a second message identifying the second channel is transmitted to the second device.

In another example, a method to receive data via a communication channel is provided. Software configured to manage the downloading of one or more data files is received by a device, and stored in a memory. A request for at least one desired data file is transmitted, by the device, under control of the software, a message specifying a channel associated with the at least one desired data file is received, and the channel is accessed, in response to the message. A first portion of the at least one desired data file is received via the channel during a first transmission cycle, and a second portion of the at least one desired data file is received via the channel during a second transmission cycle. The at least one desired data file is assembled based on the first and second portions. The one or more software applications may comprise at least one operating system. The specified channel may comprise at least one radio-frequency channel.

The at least one desired data file may be partitioned and compressed. In one example, the method further comprises tuning to the channel, receiving a set of data packets via the channel, and assembling the set of data packets into a first data file. The method may also comprise decompressing the first file, generating a second data file, retrieving, from the second data file, at least two partitions associated with the at least one desired data file and address information indicating one or more memory addresses associated with the respective partitions, and storing the at least two partitions in a storage in the device, based on the address information.

The message may further comprise second information indicating a number of data packets associated with at least one desired data file. In one example, first data packets are received starting from an intermediate data packet of the at least one desired data file until a final data packet of the at least one desired data file. After receiving the final data packet, second data packets are received starting from a first data packet of the at least one desired data file at least up to the intermediate data packet, and the at least one desired data file is assembled based on the first and second data packets.

The method may also comprise receiving, during at least one first transmission cycle, a plurality of first data packets associated with the at least one desired data file, and determining that one or more second data packets associated with the at least one desired data file were not received. The one or more second data packets are received during at least one second transmission cycle occurring after the at least one first transmission cycle, and the at least one desired data file is assembled based on the plurality of first data packets and the one or more second data packets.

In another example, a method to install software onto one or more devices assembled in a manufacturing facility, via a communication channel, is provided. Software is transmitted cyclically via at least one channel accessible from within a manufacturing facility. The at least one channel is accessed automatically by at least one assembled device, in the manufacturing facility. The software is received via the at least one channel, by the at least one assembled device, and stored in at least one memory, by the at least one assembled device.

The software may be transmitted cyclically via at least one channel available from within the manufacturing facility, by a second device in the manufacturing facility. The at least one assembled device may comprise a plurality of devices. The at least one assembled device may be removed from the manufacturing facility, after the software is stored in the at least one memory. At least one additional assembled device may be placed in a location within the manufacturing facility that enables the at least one additional assembled device to access the at least one channel.

In another example, a system to transmit data to one or more devices is provided. The system comprises at least one first processor configured to transmit one or more data files cyclically via one or more respective channels. The system also comprises at least one second processor configured to receive from a device a request for at least one desired data file, and transmit to the device a message identifying a respective channel associated with the at least one desired data file.

In another example, a device to receive data via a communication channel is provided. The device comprises at least one memory configured to store data. The device also comprises at least one processor configured to receive software configured to manage the downloading of one or more data files, store the software in the memory, and transmit a request for at least one desired data file, under control of the software. The at least one processor is also configured to receive a message specifying a channel associated with the at least one desired data file, access the channel, in response to the message, and receive, via the channel, a first portion of the at least one desired data file during a first transmission cycle. The at least one processor is further configured to receive, via the channel, a second portion of the at least one desired data file during a second transmission cycle, and assemble the at least one desired data file based on the first and second portions.

In another example, a system to install software onto one or more devices assembled in a manufacturing facility, via a communication channel, is provided. The system comprises at least one first processor located in a manufacturing facility, the at least one first processor being configured to transmit software cyclically via at least one channel accessible from within a manufacturing facility. The system also comprises at least one assembled device located in the manufacturing facility, configured to automatically access the at least channel, receive the software via the at least one channel, and store the software in at least one memory.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 is a block diagram of an example of a system that may be used to transmit software and/or data to one or more devices, in accordance with an embodiment of the invention;

FIG. 2 is an example of components of a device in FIG. 1, in accordance with an embodiment of the invention;

FIG. 3A is an example of partitions within a data file, in accordance with an embodiment of the invention;

FIG. 3B is an example of a reformatted data file, in accordance with an embodiment of the invention;

FIG. 3C is an example of a compressed file, in accordance with an embodiment of the invention;

FIG. 3D is an example of a data packet used to transport data, in accordance with an embodiment of the invention;

FIG. 3E is an example of a set of data packets, in accordance with an embodiment of the invention;

FIG. 4 is an example of an installation table, in accordance with an embodiment of the invention;

FIG. 5 is an example of a device table, in accordance with an embodiment of the invention;

FIG. 6 is an example of a version table, in accordance with an embodiment of the invention;

FIG. 7 is a flowchart showing an example of a method for transmitting software or data to one or more devices, in accordance with an embodiment of the invention;

FIG. 8 is a flowchart showing another example of a method for transmitting software or data to one or more devices, in accordance with an embodiment of the invention;

FIG. 9 is a flowchart showing an example of a method for receiving software or data, in accordance with an embodiment of the invention;

FIG. 10 is a flowchart showing an example of a method for processing a software application to be multicast to one or more devices, in accordance with an embodiment of the invention;

FIG. 11 shows an example of a database, in accordance with an embodiment of the invention; and

FIG. 12 is a block diagram of an example of a system that may be used to transmit software and/or data to one or more devices, in accordance with an alternative embodiment of the invention.

### DETAILED DESCRIPTION OF THE PREFERRED EMBODIMENTS

In accordance with one embodiment of the invention, a system comprising at least one computer transmits information cyclically, from the beginning to the end, via selected multicast channels to one or more devices. As used herein, the term “multicast channel” is a communication channel in any medium that may be used to transmit information to multiple devices, and may comprise, without limitation, communication channels used in wireless transmissions, cable transmissions, transmissions via the Internet, transmissions via telephone lines, etc. As used herein, the term “information” may comprise, without limitation, one or more software applications, data, multimedia content, etc.

In one example, the system may be implemented in a facility used to manufacture devices, such as laptop computers. The computer may comprise at least one server computer, for example, which transmits selected software applications via respective wireless channels. The devices may comprise laptop computers that are assembled and need to be loaded with software. Software applications may also be downloaded onto other types of devices, such as personal computers. The devices are placed at an appropriate distance from the server computer to allow the devices and the computer to communicate wirelessly. When placed on an assembly line within an appropriate range, a respective device obtains a copy of a selected one (or more) of the software applications from the server computer via a wireless channel. In one example, the device submits to the server computer a request for a selected software application. When the request is received by the server computer, the computer identifies the device, and identifies a software application responsive to the request. The computer may select a version of the software application suitable to the requesting device, from among multiple versions of the software application. The computer also determines a wireless channel on which the identified software application is being transmitted, and transmits to the device a message identifying the channel. The requesting device receives the message and, in response, tunes to the wireless channel and downloads the desired software application. The software is cyclically, repeatedly transmitted on the wireless channel so that each device can start receiving the software at any point, and continue to receive the software until the entire package is delivered.

In other examples of embodiments of the invention, information may be multicast to devices via other media, such as through cable connections, via the Internet, via an Ethernet Switch Based network, etc. In one alternative example, methods and systems described herein may be used in a manufacturing/assembly facility to transmit information, including software such as an operating system, to assembled devices via cable connections. In another alternative example, methods described herein may be used to distribute information, including media content, to multiple devices over the Internet. The number of channels that can be used, and therefore the number of different software, data, or multimedia applications (or versions thereof) that may be multicast simultaneously, is limited by a variety of factors known in the art including characteristics of the medium used.

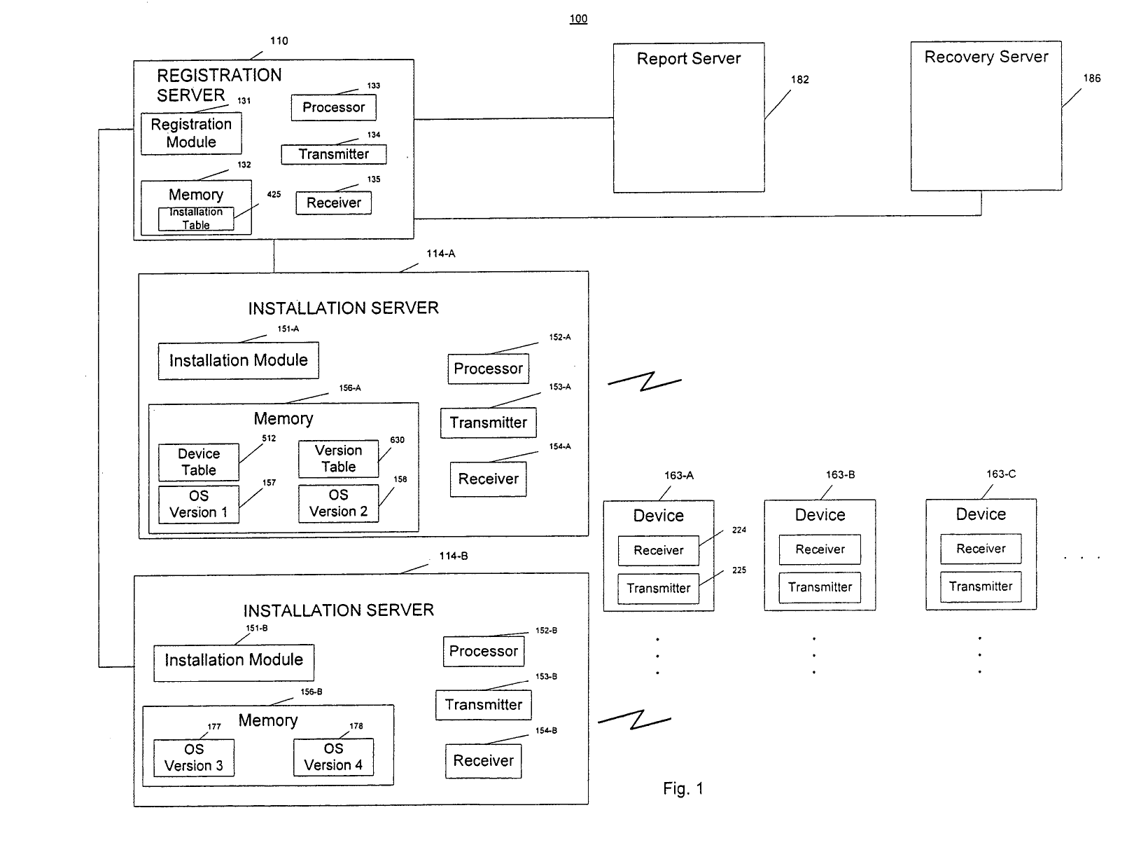

FIG. 1 is a block diagram of an example of a system 100 that may be used to transmit software and/or data to one or more devices 163-A, 163-B, 163-C, etc., in accordance with an embodiment of the invention. In this example, the system 100 comprises a registration server 110, one or more installation servers 114, a report server 182, a recovery server 186 and one or more devices 163. The registration server 110 manages initial communications with, and establishes the authorization status of, the respective devices 163, and directs each respective device 163 to communicate with a selected one of the installation servers 114-A and 114-B in order to obtain desired software applications and/or data. The installation servers 114-A and 114-B multicast various software applications and/or data via selected wireless channels to the devices 163. Two installation servers 144-A and 114-B are shown in FIG. 1; however, it should be understood that the system 100 may include any number of installation servers.

The devices 163-A, 163-B, 163-C, etc., communicate with the registration server 110, the installation server(s) 114, the report server 182 and the recovery server 186 to receive software and/or data. Three devices 163-A, 163-B and 163-C are shown in FIG. 1; however, it should be understood that any number of devices may communicate with the servers 110, 114, 182 and 186. In one example, the device 163-A represents a set of devices of a first type, the device 163-B represents a set of devices of a second type, and the device 163-A represents a set of devices of a third type. The term “type” may refer to a type of device defined by its physical characteristics, such as a laptop computer or a personal computer (PC). Alternatively, the term “type” of device may be used to distinguish one or more devices assigned to receive a particular software package, or version of a software package, such as a current version of the Microsoft Windows operating system, from another set of devices assigned to receive a different software package or version, such as an older version of the Microsoft Windows operating system.

It should be noted that the functions of each of the registration server 110, the installation server 114-A and 114-B, the report server 182 and the recovery server 186 may be performed by multiple servers, as shown. Alternatively, the functions of any or all of these servers may be performed by a single server, or by fewer servers than shown.

Registration Server

The registration server 110 comprises a registration module 131, a memory 132, a processor 133, a transmitter 134 and a receiver 135. The registration server 110 may comprise a computer, for example. The processor 133 controls the operation of the various components of the registration server 110. The processor 133 may comprise a central processing unit (CPU), for example. The processor 133 may store data in the memory 132 from time to time. The memory 132 may comprise a short-term memory device and/or one or more long-term memory devices, such as one or more disk drives.

The registration module 131 manages communications between the registration server 110 and the devices 163. The registration module 131 may comprise software, hardware, or a combination of software and hardware.

In this example, the transmitter 134 is capable of transmitting data wirelessly, and may comprise an antenna, for example. In one example, the transmitter 134 comprises a radio frequency (RF) transmitter. The receiver 135 is capable of receiving data wirelessly, and may comprise an antenna, for example. In one example, the receiver 135 comprises a radio frequency (RF) receiver. The transmitter 134 and the receiver 135 may be used to communicate wirelessly with the devices 163.

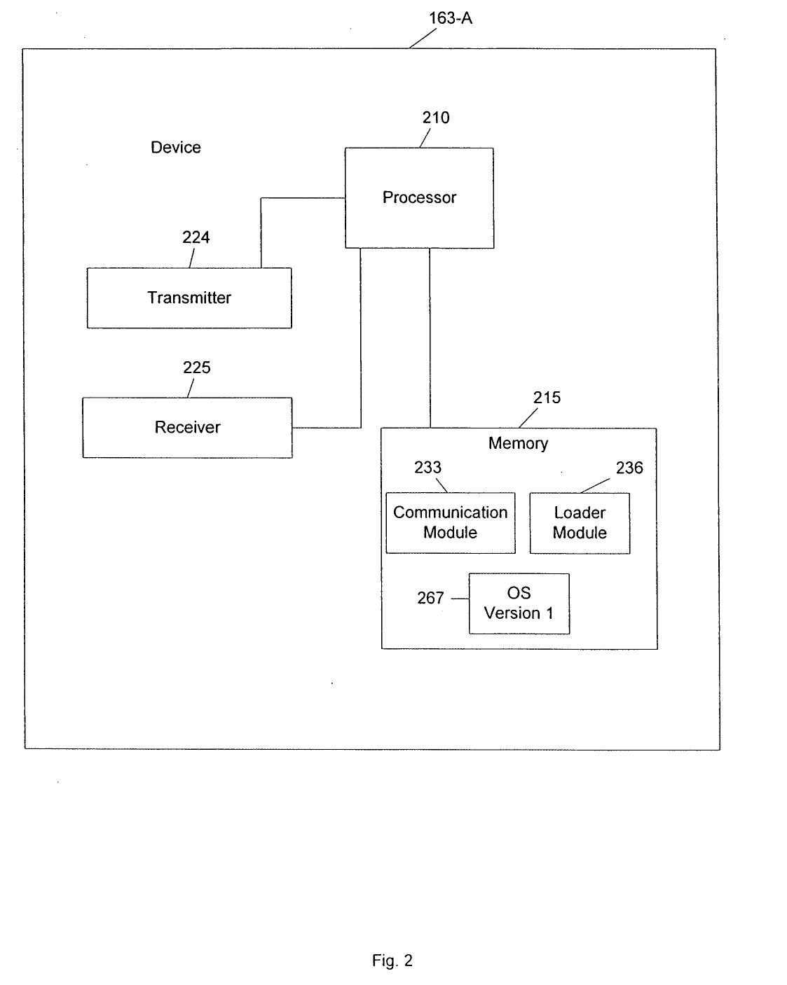

As shown in FIG. 1, each of the devices 163 also comprises a transmitter 224 and a receiver 225. The devices 163 communicate with the servers 110, 114, 182 and 186 via the receivers 224 and transmitters 225. For example, in accordance with one embodiment of the invention, a device such as the device 163-A may submit a request to the registration server 110 for a specified software application and/or data. When the registration server 110 receives such a request from the device 163-A, the registration module 131 instructs the device to communicate with an appropriate installation server 114 to receive the desired software and/or data. The components of the devices 163 are described in more detail below with reference to FIG. 2.

Installation Servers

The installation server 114-A comprises an installation module 151-A, a processor 152-A, a transmitter 153-A, a receiver 154-A, and a memory 156-A. The installation server 114-A may comprise a server computer, for example. The processor 152-A controls the operation of the various components of the installation server 114-A. The processor 152-A may comprise a central processing unit (CPU), for example. The processor 152-A may store data in the memory 156-A from time to time. One or more software applications and/or data files may also be stored in the memory 156-A. The memory 156-A may comprise a short-term memory device and/or one or more long-term memory devices, such as one or more disk drives.

The transmitter 153-A of the installation server 114-A is capable of transmitting data wirelessly, and may comprise an antenna, for example. In one example, the transmitter 153-A comprises a radio frequency (RF) transmitter. The receiver 154-A is capable of receiving data wirelessly, and may comprise an antenna, for example. In one example, the receiver 154-A comprises a radio frequency (RF) receiver.

The installation module 151-A manages the transmission of selected software applications and/or data via one or more wireless channels via the transmitter 153-A. To accomplish this, the installation module 151-A may retrieve from memory one or more software applications and/or data, and cause the transmitter 153-A to transmit the software and/or data on selected wireless channels. The installation module 151-A also manages communications between the installation server 114-A and the devices 163. For example, from time to time, the installation server 114-A may receive a communication from a device 163 requesting a desired software application and/or data. In response, the installation module 151 -A communicates with the device 163 and provides information necessary for the device to receive the requested software or data. The installation module 151 -A may comprise software, hardware or a combination of software and hardware.

In the system 100 of FIG. 1, when a device, such as the device 163-A, is instructed by the registration server 110 to communicate with a respective one of the installation servers 114, the device 163-A sends a request to the specified installation server. The device 163-A then transmits a request to the specified installation server for a desired software application and/or data. The specified installation server instructs the requesting device to tune to a specified wireless channel to receive the requested software and/or data.

The installation servers 114-A and 114-B multicast selected software applications and/or data to the devices 163. In one example, an installation server, such as the installation server 114-A, may multicast a first version of a selected software application and/or data on a first wireless channel, and a second version of the software application and/or data on a second wireless channel. In an alternative example, each installation server 114 may multicast a selected portion of a software application, or a selected portion of a data file, on a respective wireless channel. In yet another example, each of the respective installation servers 114 may multicast one or more distinct, unrelated software applications or data files on respective wireless channels.

In the example of FIG. 1, each installation server 114 comprises several components. For convenience, an example of the components and operation of the installation server 114-A are discussed below; however, it should be understood that the configuration and operation of the installation server 114-B may be similar to those of the installation server 114-A.

Devices

FIG. 2 shows a more detailed example of the device 163-A, which is to be loaded by the system 100 with software in accordance with an embodiment of the invention. The device 163-A comprises a processor 210, a memory 215, a transmitter 224, and a receiver 225. The processor 210 controls the operation of the various components of the device 163-A. The processor 210 may comprise a central processing unit (CPU), for example. The processor 210 may store data in the memory 215 from time to time. The memory 215 may comprise a short-term memory device and/or one or more long-term memory devices, such as one or more disk drives. In the illustrative example, the device 163-A may comprise a computer, such as a personal computer or a laptop computer. The device may also be a Blackberry, cell phone, personal digital assistant (PDA), game console, or multimedia device, for example.

The transmitter 224 (in the device 163-A) is capable of transmitting data wirelessly, and may comprise an antenna, for example. In one example, the transmitter 224 comprises a radio frequency (RF) transmitter. The receiver 225 is capable of receiving data wirelessly, and may comprise an antenna, for example. In one example, the receiver 225 comprises a radio frequency (RF) receiver.

A communication module 233 is stored in the memory of the device 163-A. The communication module 233 manages initial start-up communications between the device 163-A and the registration server 110. For example, when the device 163-A is turned on, the communication module 233 transmits an identifier (ID) identifying the device 163-A to the registration server 110, and a request for specified software and/or data. The communication module 233 is capable of conducting additional communications with the registration server 110, including receiving information concerning procedures for receiving the desired software and/or data, as discussed in more detail below.

Operation of the System

As mentioned in the example above, the system 100 shown in FIG. 1 may be used to install software, such as an operating system, onto multiple devices during an assembly/manufacturing process. In this example, the servers 110, 114, 182 and 186 reside in a facility used in the manufacture and assembly of laptop computers. The installation servers 114-A and 114-B store multiple versions of the operating system; each version being suitable for a different type of device. For example, a first version of the operating system may be suitable for devices containing a particular Intel microprocessor, a second version of the operating system may be suitable for devices containing an particular IBM microprocessor, etc. In another example, a first version of the operating system may be suitable for Windows-based computers, and a second version of the operating system my be suitable for MAC OS-based Apple computers. The installation servers 114-A and 114-B transmit the various versions of the operating system cyclically on respective wireless channels.

In the illustrative example, each of the devices 163 comprises a laptop computer that has been assembled and needs to be loaded with software. As discussed further below, the system 100 is capable of identifying a device, such as device 163-A, determining which version of the operating system is suitable for the device, and instructing the device-how to download the appropriate version of the operating system. It should be understood that while in this example, the devices 163 comprise laptop computers, in alternative examples, the devices may comprise any type of device to which there is a need to transmit software and/or data. It should also be understood that the uses of the system and method described herein are not limited to downloading an operating system onto computers. Systems and methods described herein may be used to transmit any software or data onto any type of device. As mentioned above, in one alternative application of various methods described herein, multimedia content may be cyclically transmitted via selected multicast channels, which may comprise channels in a wireless medium, channels in a cable network, channels used to transmit information via the Internet, etc. For example, a provider of multimedia services, including the distribution of videos, may use methods described herein to distribute multimedia content, including videos, via the Internet to devices used by subscribers of the service.

Each of the installation servers 114 manages the transmission of one or more versions of the operating system. In the illustrative example, two versions of the operating system (“OS Version 1” 157 and “OS Version 2” 158) are stored in the memory 156-A of the installation server 114-A. Two additional versions of the operating system (“OS Version 3” 177 and “OS Version 4” 178) of the operating system are stored in the memory 156-B of the installation server 114-B. Each version is suitable for a particular set of devices. For example, the OS Version 1 (157) may be suitable for device 163-A, the OS Version 2 (158) may be suitable for device 163-B, etc.

In the illustrative example, before being stored in the memory of a selected installation server, a respective version of the operating system is stored in a laptop computer (the “test computer”). Typically, a given version of an operating system is divided into partitions and stored in selected locations within the test computer's memory. For example, the OS Version 1 (157) may be divided into five partitions and stored in various locations in the memory of a test computer. Subsequently, when the OS Version 1 (157) is stored in the installation server 114-A, information relating to the manner in which the OS Version 1 was partitioned, and information indicating the locations where the various partitions were stored in the test computer's memory, are also stored in the installation server 114-A in associated with the OS Version 1.

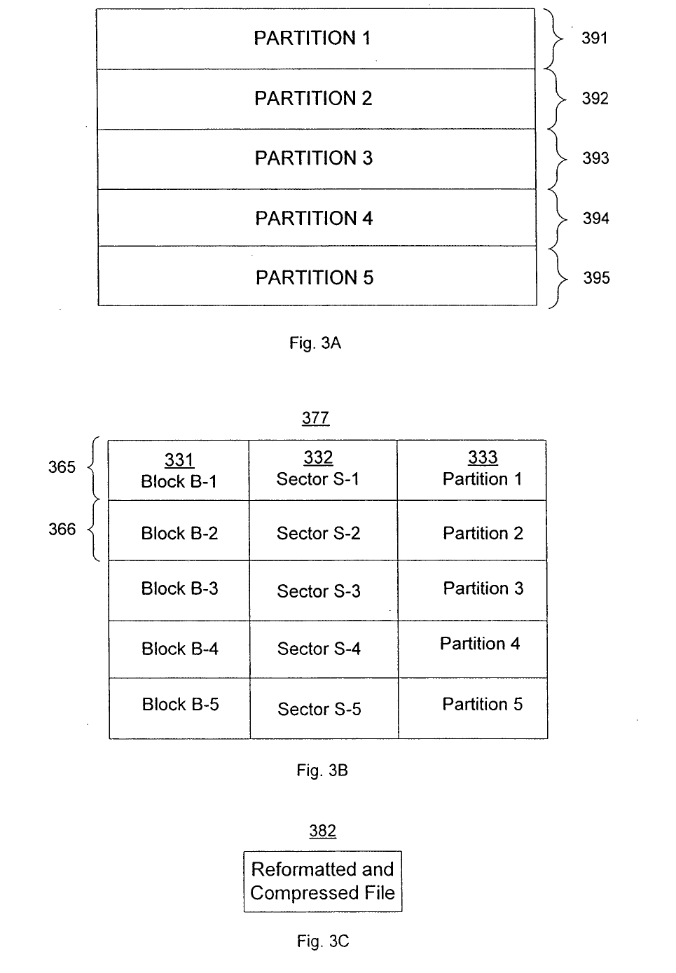

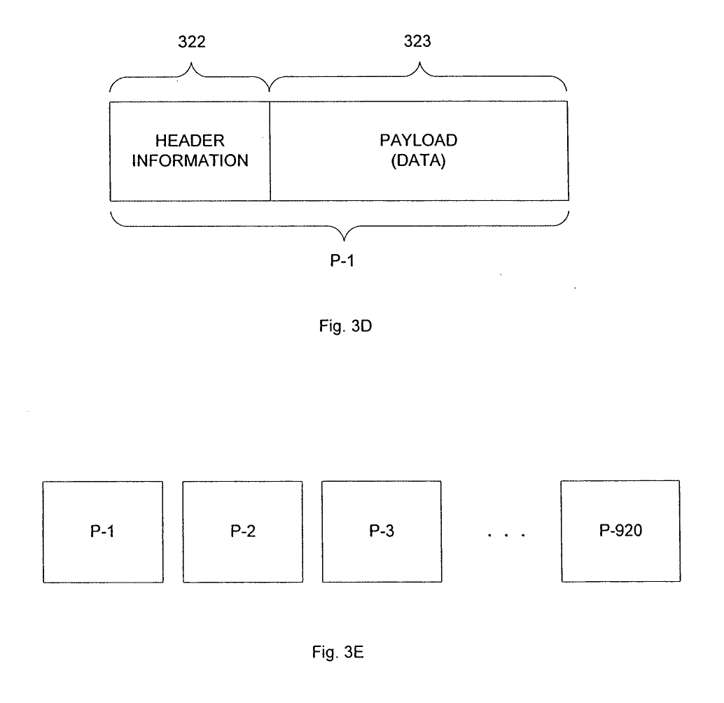

In accordance with an embodiment of the invention, the installation servers 114-A and 114-B reformat and packetize each respective version of the operating system prior to transmitting the respective versions to the devices 163. For example, the installation module 151-A (in the installation server 114-A) may retrieve the information concerning how the OS Version 1 (157) was partitioned in the test computer, and use this information to reformat the OS Version 1 (157) into multiple partitions, as shown in FIG. 3A. In this example, the OS Version 1 (157) is reformatted into the five partitions 391-395. The installation module 151-A then creates a new, reformatted file containing the five partitions 391-395 and additional information, such as address information indicating where each respective partition was stored in a test computer. FIG. 3B is an example of a reformatted data file 377, in accordance with an embodiment of the invention. Referring to portion 365 of the reformatted file 377, for example, field 331 holds information identifying a block address B-1, field 332 holds information identifying a sector address S-1, and field 333 contains the partition 391. The block and sector information in portion 365 indicates one or more storage locations where the partition 391 was stored in a test computer. The block and sector information also indicates where the partition 391 is to be stored in a receiving device. Similarly, block and sector information associated with each of the other partitions 392-395 is included in the reformatted file 377. It should be noted that while in the illustrative example, the address information in the reformatted file 377 (including block and sector information as shown in FIG. 3B) is determined using a test computer, in other examples, address information for inclusion in a reformatted file may be generated in other ways, such as by using an algorithm.

The reformatted file may also be compressed. In this example, the installation module 151-A may compress the reformatted file 377 to generate a reformatted and compressed file. FIG. 3C is an example of a compressed file 382 generated based on the reformatted file 377, in accordance with an embodiment of the invention. The installation module 151-A may utilize standard, well-known compression techniques such as, for example, Huffman coding. The installation module 151-A may use commercially-available software; alternatively, custom-designed algorithms may be utilized.

The method described above may be used to reformat and compress an operating system such as the Microsoft Windows XP operating system. In one example, the operating system may reside on a disk of size 100 G Bytes. The reformatted version may have a size of 6 G Bytes. The compressed version may have a size of 5 G Bytes.

The installation module 151-A converts the compressed file 382 into a set of data packets. FIG. 3D is an example of a data packet P-1 used to transport data associated with the compressed file 382, in accordance with an embodiment of the invention. Data packet P-1 comprises a header information segment 322, and a payload segment 323 containing data from the compressed file 382. The header segment 322 may include information indicating the length of the data packet P-1 and the type of data contained in the payload segment 323, for example. The header segment 322 may also hold an identifier associated with the data packet P-1.

FIG. 3E is an example of a set of data packets that may be used to transport the data associated with a compressed file such as the compressed file 382, in accordance with an embodiment of the invention. In this example, the data associated with the compressed file 382 is carried by a set comprising nine hundred and twenty data packets P-1, P-2, P-3, . . . , P-920. In this example, each data packets P-1 to P-920 contains within its header segment a unique identifier comprising a value between one and nine hundred and twenty (inclusive) which identifies the packet. Thus, referring again to FIG. 3D, the data packet P-1 may carry the identifier ‘1’ in the header segment 322. The data packet P-2 may carry the identifier ‘2’ in its header segment, etc. Other types of identifiers may be used in other examples. It should also be understood that while in this example, the compressed file 382 is converted into a set of nine hundred and twenty data packets, in other examples, any number of data packets may be used. The use of data packets to transmit data is well-known.

In the illustrative example, the packetized version of the compressed file 382 is transmitted repeatedly (cyclically) via a selected radio-frequency (RF) channel. Thus, the installation module 151-A (in the installation server 114-A) causes the transmitter 153-A to transmit the data packets P-1 to P-920 in sequential order, and then start again with data packet P-1 and repeat the transmission continuously during a predetermined period of time. For example, the transmission may be repeated continuously during the hours of operation of the manufacturing facility in which the devices 163 are assembled. The other stored versions of the operating system are also transmitted cyclically on other selected RF channels.

In this example, the installation module 151-A causes the OS Version 1 (157) to be cyclically multicast on a first RF channel C-1 to the device 163-A (and to other devices of the same type), and the OS Version 2 (158) to be cyclically multicast on a second RF channel C-2 to the device 163-B (and to other devices of the same type). Similarly, the installation server 114-B multicasts the OS Version 3 (177) and the OS Version 4 (178) on third and fourth RF channels C-3 and C-4, respectively, to selected devices. In alternative examples, software and/or data may be transmitted on non-RF channels.

As a result, each version of the operating system is multicast, via wireless transmission, to a set of devices in the manufacturing facility. Each device may tune to a selected channel and download a version of the operating system suitable for that particular device. The term “multicast” is used herein to mean a transmission of software and/or data to a defined set of devices.

The devices 163 are placed within a suitable distance of the registration server 110, the installation server 114-A and the installation server 114-B (so that the devices 163 can communicate wirelessly with the servers). The devices 163 are placed within an area defined by the range of the transmitters and receivers within the devices 163, and the range of the transmitters and receivers within the servers 110 and 114.

Each device 163 is turned on and begins to communicate with the registration server 110 to initiate the software download procedure. For convenience, the following discussion refers to the device 163-A; however, it should be understood that the other devices 163 may communicate with the servers, and receive data, in a manner similar to that described herein. After the device 163-A is turned on, the communication module 233 transmits an identifier to the registration server 110 in order to identify itself. The communication module 233 may provide an identifier unique to the device 163-A, for example, such as the MAC address of the network adaptors or the serial number of the device 163-A. The registration module 131 in the registration server 110 receives the signal from the device 163-A and, in response, verifies the device's identity and authorization to receive software and/or data through well-known authentication mechanisms. If the device's authorization is established, the registration module 131 causes a first additional software application to be transmitted to the device 163-A. This software application, referred to as the “loader module” 236, is received by the device 163-A and stored in the memory 215, as shown in FIG. 2.

The loader module 236 is activated and henceforth manages the process of downloading software onto the device 163-A, and storing the software in the memory of the device 163-A. The loader module 236 transmits to the registration module 131 an identifier associated with the device 163-A, and a message requesting instructions concerning the procedure for receiving an appropriate version of the operating system. The registration module 131 receives the request and, in response, accesses an installation table to identify an installation server that can provide a suitable version of the operating system to the device 163-A, and a recovery server that can assist the device in case of transmission errors.

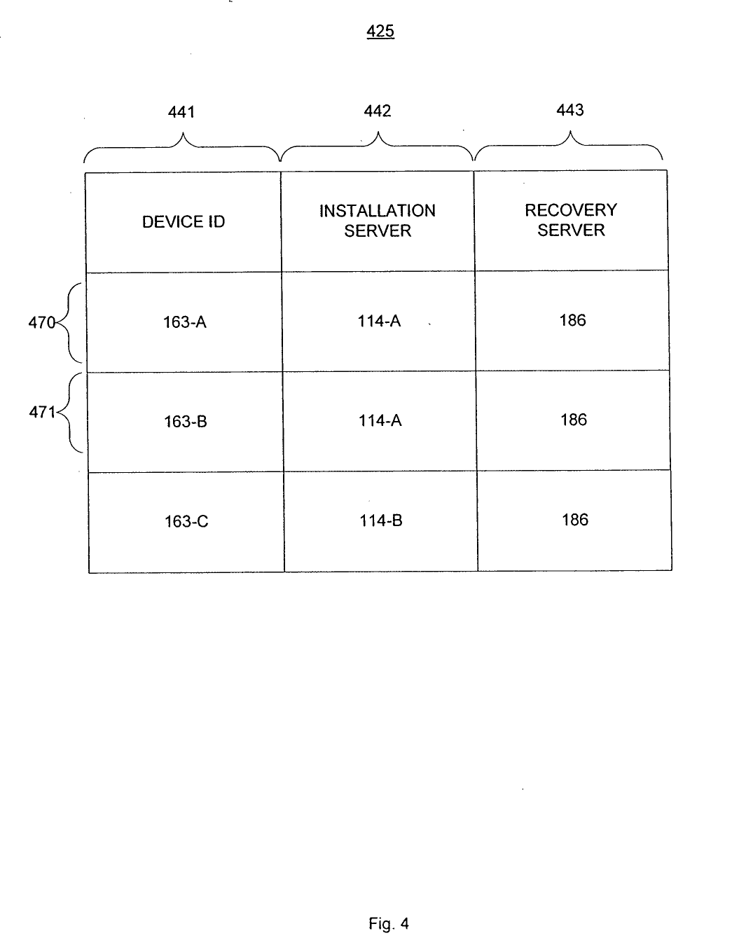

FIG. 4 shows an example of an installation table 425. The installation table 425 comprises a column 441 containing identifiers of various devices, and a column 442 containing information indicating which of the installation servers 114 each respective device must communicate with to receive a suitable version of the operating system. The installation table 425 also includes a column 443 identifying a recovery server that each respective device is to communicate with in case the device fails to receive all or part of a transmission due to a transmission error. For example, referring to record 470, the device 163-A needs to communicate with the installation server 114-A to receive a suitable version of the operating system, and is to communicate with the recovery server 186 in case the device 163-A fails to receive all or part of the operating system due to a transmission error. Referring to FIG. 1, the installation table 425 may be stored in the memory 132 (in the registration server 110).

Accordingly, when the registration module 131 receives the identifier of the device 163-A and the request for instructions, the registration module 131 accesses the installation table 425, and determines from the record 470 that the device 163-A should communicate with the installation server 114-A to obtain a suitable version of the operating system, and with the recovery server 186 in case of any transmission errors. The registration module 131 transmits to the device 163-A a message identifying the installation server 114-A and the recovery server 186.

The loader module 236 (in device 163-A) receives the message and initiates communications with the installation server 114-A. The loader module 236 transmits a message to the installation server 114-A requesting a suitable version of the operating system. The installation module 151-A receives the message from the device 163-A and, in response, accesses a device table to determine which version of the operating system the device 163-A should receive.

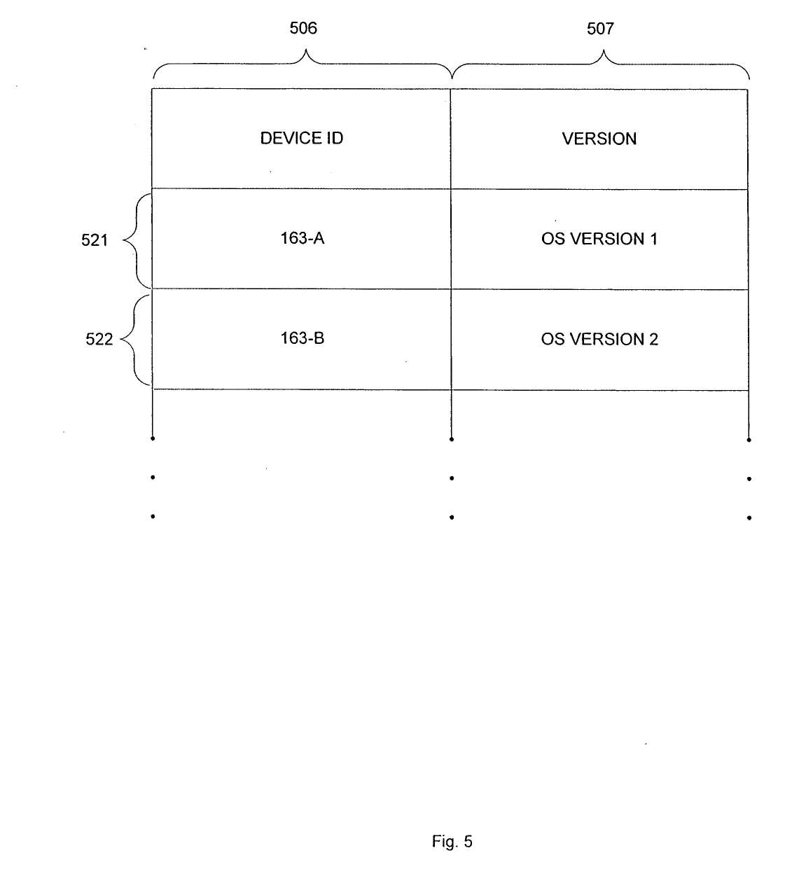

FIG. 5 shows an example of a device table 512, in accordance with an embodiment of the invention. The device table 512 comprises a column 506 holding one or more device identifiers, and a column 507 indicating a version of the operating system that the respective device should receive. For example, referring to record 521, the device 163-A should receive the “OS Version 1” version of the operating system. Referring to FIG. 1, the device table 512 may be stored in the memory 156-A (in the installation server 114-A).

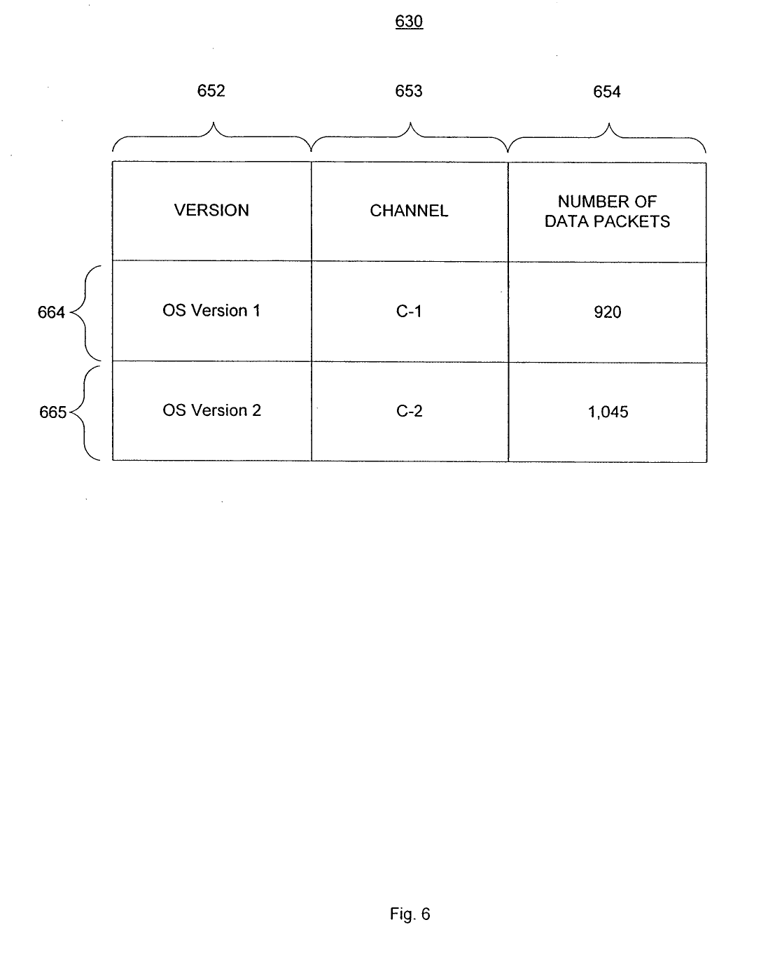

The installation module 151-A additionally examines a version table to determine a wireless channel on which the relevant version of the operating system is being multicast. FIG. 6 shows an example of a version table 630, in accordance with an embodiment of the invention. The version table 630 comprises a column 652, identifying various versions of the operating system, and a column 653, indicating a transmission channel on which the respective versions are transmitted. The table 630 additionally comprises a column 654 indicating the number of data packets associated with each respective version of the operating system. For example, referring to row 664, the “OS Version 1” version of the operating system is transmitted on channel C-1 and is transmitted in the form of nine hundred and twenty data packets. Referring to FIG. 1, the version table 630 may be stored in the memory 156-A (in the installation server 114-A.

After consulting the device table 512 and the version table 630, the installation module 151-A transmits a message wirelessly to the device 163-A instructing it to tune to channel C-1 and receive the “OS Version 1” version of the operating system. The installation module 151-A also informs the device 163-A of the number of data packets associated with the transmission. In this instance, the installation module 151-A informs the device 163-A that the transmission comprises 920 data packets.

In an alternative example, the device table 512 and the version table 630 may be maintained by the registration server 110. In this alternative example, the registration server 100 (instead of the installation server 114) determines an appropriate version of the requested operating system, and a wireless channel on which the version is being transmitted, and communicate such information to the various devices 163. Thus, in this alternative example, each of the devices 163 receives instructions concerning which channel it should tune to from the registration server 110 (instead of from the installation servers 114).

Returning to the illustrative example, when the loader module 236 (in the device 163-A) receives the message from the installation module 151-A, the loader module 236 causes the receiver 225 to tune to the channel C-1. The receiver 225 tunes to the channel C-1 and begins to receive data packets associated with the OS Version 1 (157). The loader module 236 receives the data packets and assembles the compressed file 382 (shown in FIG. 3C). The loader module 236 decompresses the compressed file 382 to recover the reformatted file 377 (shown in FIG. 3B). The loader module 236 monitors the data packets that are received to ensure that all of the data associated with the OS Version 1 (157) are received. In this example, the loader module 236 monitors the received data packets to ensure that the 920 distinct data packets P-1 to P-920 associated with the compressed file 382 are received. For example, the loader module 236 may examine the identifier in each data packet's header segment to determine which data packets are received and which have not yet been received. The loader module 236 may store data packets in a temporary location within the memory 215 until all of the data associated with the OS Version 1 (157) is received and reassembled.

After the loader module 236 reassembles the compressed file 382 and recovers the reformatted file 377, the loader module 236 extracts the data associated with each of the partitions 391-395 and the block and sector information associated with each respective partition. The loader module 236 causes each of the partitions 391-395 to be stored in the memory 215 (in the device 163-A) at the address (or addresses) defined by the associated block and sector information. Thus, referring back to FIG. 3B, the partition 1 (391) is stored in the memory 215 at a location associated with block B-1, sector S-1.

The loader module 236 in the device 163-A may from time to time transmit a message to the registration module 131 informing the registration module 131 of the status of the download procedure with respect to the device 163-A. For example, the loader module 236 informs the registration module 131 when the device 163-A tunes to the channel C-1 and begins to receive data, when the device 163-A has completed the download procedure, and if any errors occur during the download process. The loader module 236 may also from time to time transmit a message to the registration module 131 indicating which data packets have been received, and which have not been received. If the loader module 236 detects an error in the transmission of the operating system via the channel C-1, the loader module 236 may also transmit an error message to the recovery server 186.

It should be understood that the device 163-A may commence receiving data packets in the “middle” of a transmission cycle. By way of example, suppose that when the device 163-A tunes to the channel C-1, the data packet identified as data packet P-317 is being transmitted. The device 163-A accordingly receives the data packet P317 and continues to receive data packets as they arrive, storing them temporarily, until the end of the current transmission cycle (i.e., until the data packet P-920 is received). The remaining data packets (i.e., data packets P-1 to P-316) are therefore received during the next transmission cycle. Similarly, if the loader module 236 determines that one or more data packets are not received during a transmission, due to a temporary transmission problem, for example, the loader module 236 may pause during one or more transmission cycles and then attempt to receive the missed data packets during a subsequent cycle. In this manner, the loader module 236 ensures that all of the data packets associated with the relevant version of the operating system are received.

Alternatively, if the device 163-A fails to receive one or more data packets, for example, data packets P-554 and P-555, the device 163-A may retrieve the missing data packets from the recovery server 186. The recovery server 186 stores sets of data packets transmitted by each of the installation servers 114-A and 114-B. For example, the recovery server 186 stores the data packets P-1 to P-920 (shown in FIG. 3 E) associated with the OS Version 1 (157). If the device 163-A fails to receive one or more data packets while downloading the OS Version 1 (157), the device 163-A may be connected by cable to the recovery server 186. In this case, the loader module 236 informs the recovery server 186 which data packets were missed, and the recovery server 186 transmits the missed data packets to the device 163-A.

As mentioned above, the system 100 is capable of multicasting multiple versions of the operating system simultaneously. Simultaneous multicasting allows the system 100 to transmit the operating system to different types of devices simultaneously. This capability may enable a manufacturing facility to download an operating system into an increased number of devices simultaneously.

By way of example, suppose that the device 163-B is a device that is of a different type from the device 163-A. For example, the device 163-B may comprise a device having components different from those of the device 163-A and require a different driver set. Consequently, the device 163-A and the device 163-B may require different versions of the operating system. Thus, for example, while the device 163-A is communicating with the system 100 and receiving (a reformatted and packetized version of) the OS Version 1 (157) in the manner described above, the device 163-B may also be turned on, and begin to communicate with the registration server 110. Referring again to FIG. 4, the registration module 131 determines from row 471 of the installation table 425 that the device 163-B should communicate with the installation server 114-A, and instructs the device 163-B accordingly.

In this case, as mentioned above, the installation server 114-A stores an OS Version 2 (158) in the memory 156-A, in addition to the OS Version 1 (157). While the OS Version 1 (157) is being transmitted via the wireless channel C-1, the installation module 151-A causes the OS Version 2 (158) to be transmitted simultaneously via a second wireless channel C-2. The OS Version 2 (158) is retrieved from memory and reformatted, compressed and packetized in the manner described above with reference to FIGS. 3A-3E, and the resulting reformatted, compressed and packetized file is multicast via channel C-2.

When the device 163-B identifies itself to the installation server 114-A, the installation module 151-A examines the device table 512 (shown in FIG. 5), and (referring to row 522) determines that the device 163-B should receive the OS Version 2 (158), which is stored in the memory 156-A. In this example, the installation module 151-A also consults the version table 630 (shown in FIG. 6) and determines from row 665 that the OS Version 2 (158) is transmitted on channel C-2, and comprises one thousand forty-five (1,045) data packets. The installation module 151-A sends a message containing this information to the device 163-B.

The device 163-B receives the message from the installation module 151-A and, in response, tunes to the channel C-2 to receive the OS Version 2 (158). The device receives the data packets associated with the OS Version 2, reassembles the compressed file, and decompresses it. The device 163-B extracts the data associated with the OS Version 2 (158) and the address-related information (including block and sector information), and stores the OS Version 2 (158) at the specified address locations.

It should be noted that two or more versions of the operating system may alternatively be transmitted via a single channel. For example, the OS Version 1 and the OS Version 2 may be multiplexed and transmitted simultaneously via a single wireless channel. In another example, the OS Version 1 and the OS Version 2 may be alternately transmitted via a single channel.

It should also be noted here that the transmission methods described herein may be used to transmit distinct, unrelated software applications to different devices. For example, a video game may be transmitted to a first set of devices, while a word processing application may be transmitted to a second set of devices.

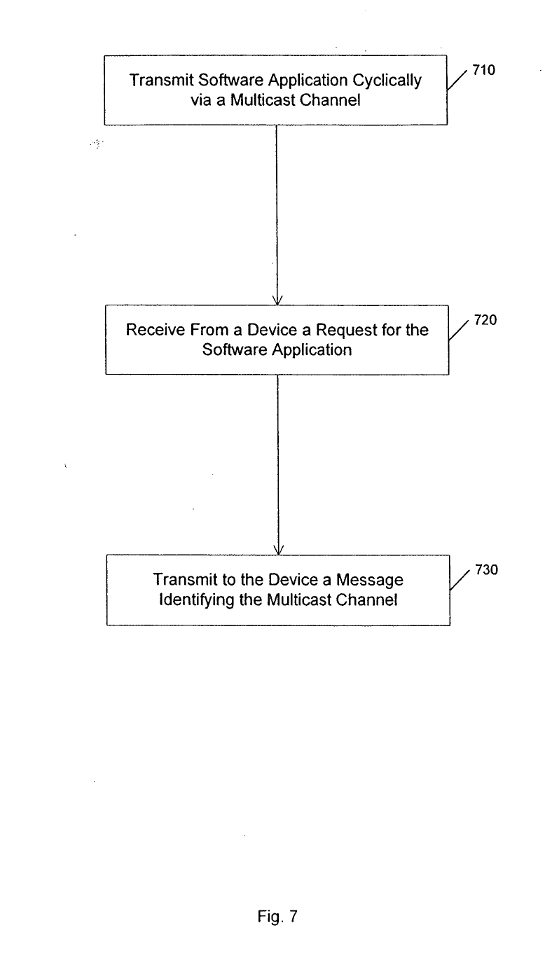

FIG. 7 is a flowchart showing an example of a method for transmitting information, such as a software application, to one or more devices, in accordance with an embodiment of the invention. At step 7 10, the software application is cyclically transmitted via a multicast channel. Thus, the installation server 151-A may multicast the application, for example, via a wireless channel. At step 720, a request for the software application is received from a device. The registration server 110 may receive the request, for example. At step 730, a message identifying the multicast channel is transmitted to the device in response to the request. The installation server 151-A may provide the channel information to the device, for example.

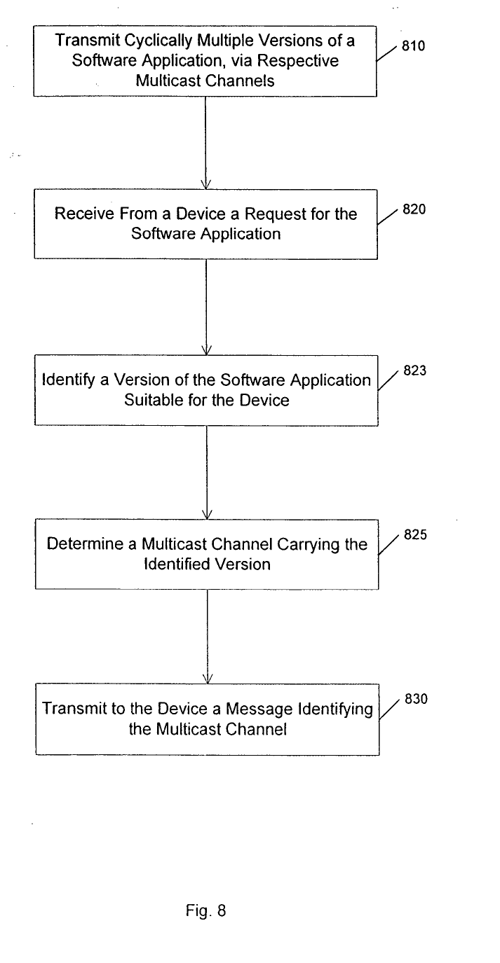

FIG. 8 is a flowchart showing another example of a method for transmitting information, such as a software application, to one or more devices, in accordance with an embodiment of the invention. At step 810, multiple versions of the software application are transmitted cyclically, via respective multicast channels. At step 820, a request for the software application is received from a device. At step 823, a version of the software application suitable for the device is identified. At step 825, a multicast channel carrying the identified version is determined, and at step 830 a message identifying the multicast channel is transmitted to the device.

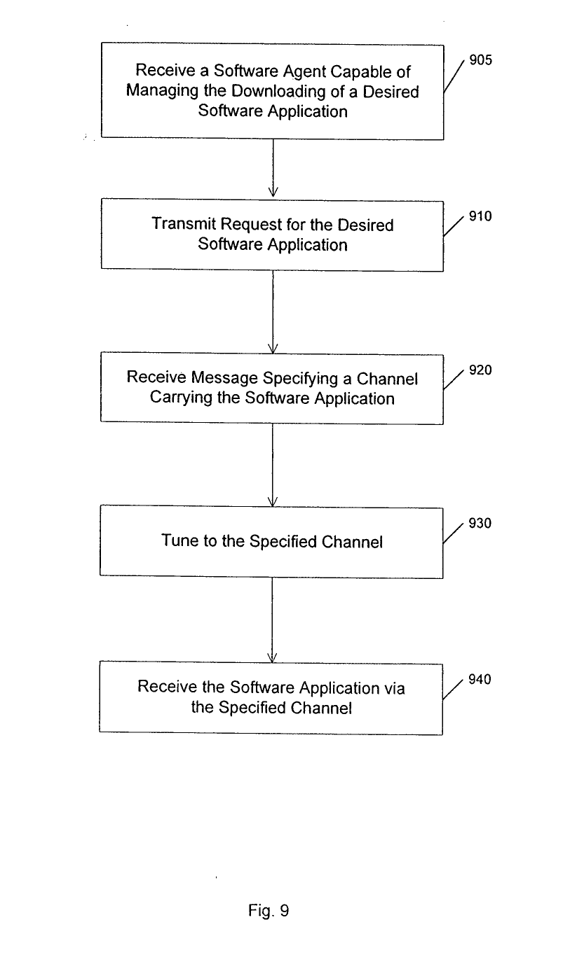

FIG. 9 is a flowchart showing an example of a method for receiving information, such as a software application, by a device, in accordance with an embodiment of the invention. At step 905, a software agent capable of managing the download of the desired software application is received by the device. In the illustrative example, the device 163-A receives the loader module 236 and stores it in memory. At step 910, a request for the software application is transmitted by the device. In the example, the loader module 236 transmits a request for a desired operating system to the registration server 110, for example. After receiving instructions from the registration server 110, the device 163-A communicates with the installation server 114-A. At step 920, a message specifying a channel carrying the software application is received by the device. In the example, the device 163-A receives from the installation server 114-A a message indicating a wireless channel on which a suitable version of the operating system is being transmitted. At step 930, the channel is accessed. Therefore, the loader module 236 causes the device 163-A to tune to the specified wireless channel. At step 940, the software application is received via the specified channel. The device 163-A receives the desired operating system via the specified wireless channel, and stores it in memory.

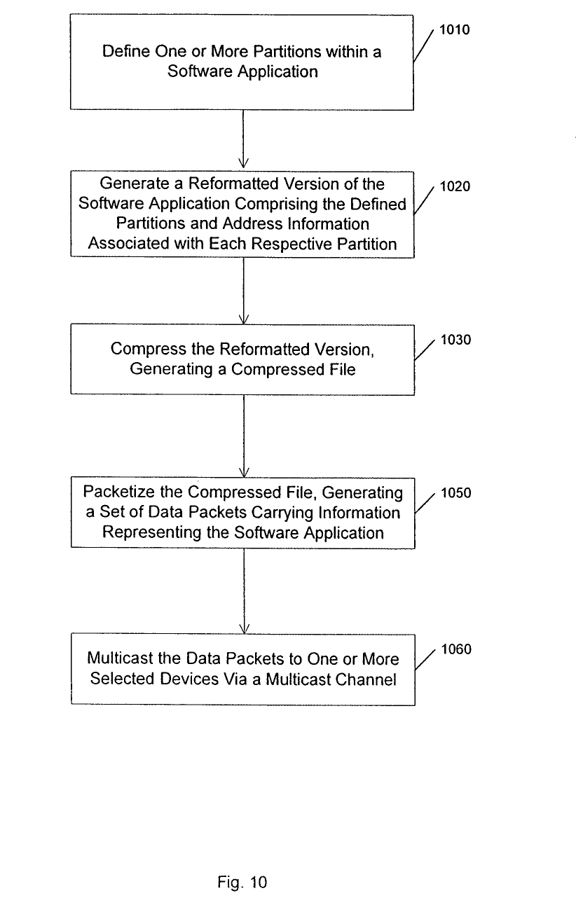

FIG. 10 is a flowchart showing an example of a method for processing information, such as a software application, to be multicast, in accordance with an embodiment of the invention. At step 1010, one or more partitions are defined within the software application. In the illustrative example, the installation module 151-A divides the OS Version 1 (157) into five partitions, as shown in FIG. 3A. At step 1020, a reformatted version of the software application is generated, comprising the defined partitions and address information associated with the respective partitions. Thus, the installation module 151-A reformats the OS Version 1 (157) to generate the reformatted file 377, shown in FIG. 3B. At step 1030, the reformatted version of the software is compressed, generating a compressed file. In the example, the installation module 151-A compresses the reformatted file 377, generating the compressed file 382, shown in FIG. 3C. At step 1050, the compressed file is packetized to generate a set of data packets carrying information representing the software application. The installation module 151-A accordingly packetizes the compressed file 382 to create the set of data packets P-1 to P-920, shown in FIG. 3E. At step 1060, the data packets are multicast cyclically to one or more selected devices via a multicast channel. In the example, the installation module 151-A causes the data packets P-1 to P-920 to be multicast, via a wireless channel, to selected devices, including the device 163-A.

Information received by a device is verified using a Checksum. In one example, the installation server 114-A adds one or more Checksum values to the data file 157 shown in FIG. 3A prior to multicasting the data file 157, and the device 163-A uses the Checksum value(s) to verify the integrity of the information as it is received. The Checksum value may comprise a hash value generated using a hash function. The use of hash functions is well-known in the art. In this example, the installation server 114-A uses a known hash function to generate a hash value based on each of the five partitions 391-395. The five hash values derived from the partitions 391-395 are appended to the data file 157. The resulting file is reformatted, compressed, and packetized, and multicast to the devices 163. When a device, such as the device 163-A, receives the file, the device decompresses the data file, and extracts the hash values therefrom. The device 163-A uses the known hash function to compute a hash value or values from each of the partitions 391-395, and compares these against corresponding hash values received in the data file. If the computed hash values match the received hash values, the contents of the data file are verified. The installation server 114-A may additionally include a further level of verification by concatenating the five hash values mentioned above to generate a combined value. An additional hash value is calculated based on the combined value. This additional hash value is included in the data file and delivered to the device 163-A, which uses the additional hash value to verify other hash values. In other examples, other types of checksum values may be used.

In still another alternative example of an embodiment of the invention, the methods described above may be performed via cable connection instead of via wireless connections. The cable connection may comprise a coaxial cable, for example. In another example, the cable connection may comprise fiber optic cable. Thus, a device, such as the device 163-A, may communicate with the registration server 110 and with the installation servers 114 via cable connections. In this example, the installation servers 114 may multicast one or more software applications and/or data via a cable connection. In this example, various software applications and/or data files may be multiplexed and transmitted via a cable connection simultaneously. Each respective device may extract a desired software application and/or data file from the multiplexed stream.

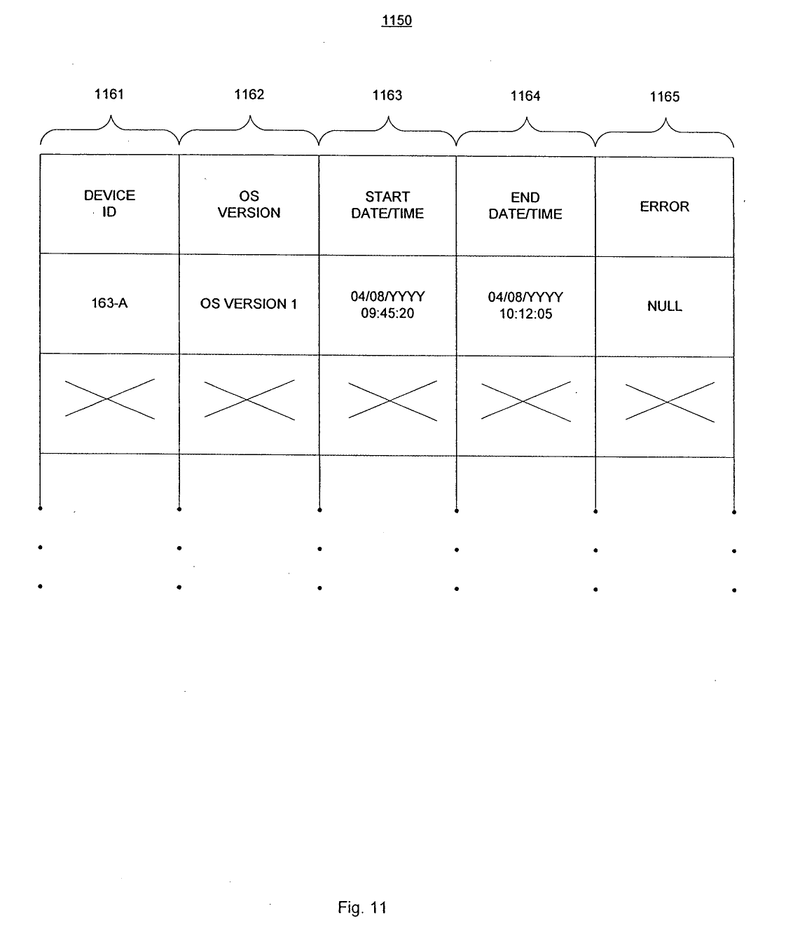

Returning to FIG. 1, the system 100 may also comprise a report server 182. The report server 182 monitors the installation of the operating system onto the devices 163. For example, the report server 182 may store in a database information concerning the progress of the download procedure with respect to each of the devices 163. FIG. 11 shows an example of a database 1150 that may be maintained by the report server 182 for this purpose. The database 1150 comprises columns 1161-1165. Column 1161 stores identifiers for one or more of the devices 163. Column 1162 identifies a version of the operating system that is transmitted to a respective device. Columns 1163 records the date and time when the transmission of the operating system to a respective device starts; column 1164 records the date and time when the transmission ends. Columns 1165 records if and when an error occurs in the transmission of the operating system to a respective device. In other examples, additional columns and fields in the database 1150 may be added to record other information relating to the transmission of the operating system to the devices 163.

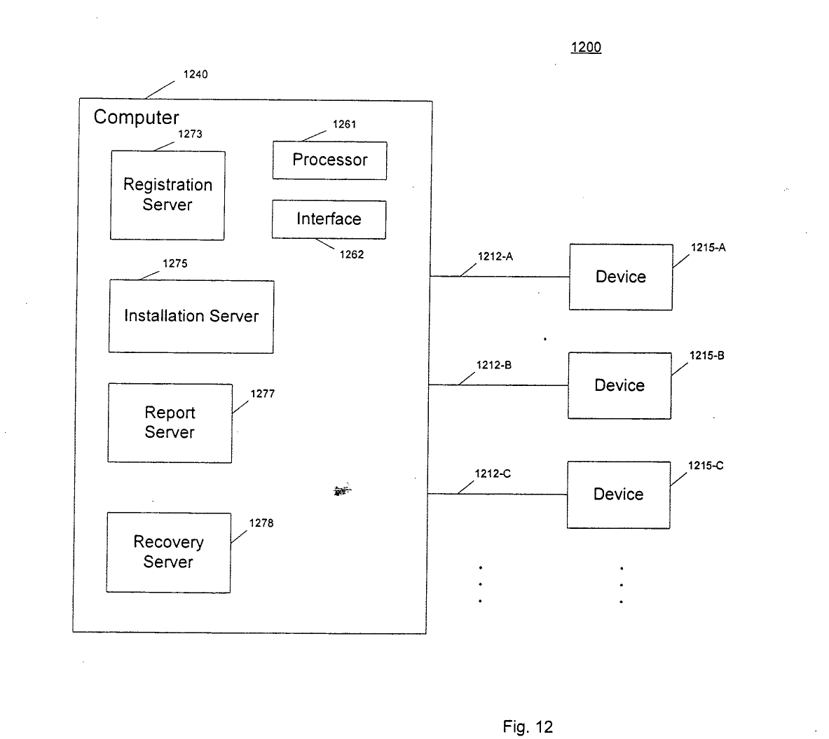

In an alternative embodiment of the invention, a device is connected to an installation server via a cable connection, and receives a desired software application via the cable connection. FIG. 12 is a block diagram of an example of a system 1200 that may be used to transmit software and/or data to one or more devices, in accordance with this embodiment. In this example, a computer 1240 comprises a processor 1261, an interface 1262 with connections to a registration server 1273, an installation server 1275, a report server 1277, and a recovery server 1278. The system 1200 may be used within a facility that manufactures and assembles electronic devices, such as laptop computers, for example.

The processor 1261 orchestrates the operations of the various components of the computer 1240, including the interface 1262, the registration server 1273, the installation server 1275, the report server 1277, the recovery server 1278, and networking devices (not shown) to facilitate better Quality of Service (QoS) support of the system's operation. The processor 1261 may comprise a central processing unit (CPU) or a microprocessor, for example. The processor 1261 may be controlled by hardware and/or software. The interface 1262 facilitates communications between the various components of the computer 1240 and the devices 1215 via the cable connections 1212. The interface 1262 may comprise an Internet Network Interface, for example.

The registration server 1273 functions in a manner similar to the registration server 110 of FIG. 1. Thus, the registration server 1273 manages initial communications with the devices 1215, and directs each device to communicate with the installation server 1275.

In this example, the installation server 1275 functions in a manner similar to the respective installation servers 114 of FIG. 1. Thus, the installation server 1275 transmits cyclically one or more software applications and/or data via the cable connections 1212. Prior to being transmitted via a selected channel, each respective software application and/or data is reformatted, compressed, and packetized in a manner similar to that described above with reference to FIGS. 3A-3E. In this manner, the installation server 1275 may transmit an operating system or other software program to the devices 1215 via the cable connections 1212. In one example, a single software application is transmitted cyclically via each of the cable connections 1212. In other examples, multiple software applications, or multiple versions of a software application, are multiplexed into a single data stream comprising multiple data channels. The multiplexed data stream is then transmitted simultaneously and cyclically, over each of the cable connections 1212. While only one installation server 1275 is shown in FIG. 12, it should be understood that the computer 1240 may comprise multiple installation servers.

In this example, a device, such as device 1215-A, is connected to a cable connection, such as the connection 1212-A, and is turned on. After being turned on, the device 1215-A communicates with the registration server 1273. The registration server 1273 identifies and authorizes the device 1215-A, and directs the device to communicate with the installation server 1275. The device 1215-A identifies itself to the installation server 1275 and submits a request for a desired software application and/or data. In response, the installation server 1275 transmits a message to the device 1215-A specifying a channel on which the desired software and/or data is being transmitted. The device 1215-A receives the message, tunes to the specified channel, and receives the data packets containing the desired software and/or data. In a manner similar to that described above, the device reassembles, decompresses, and stores the software and/or data in its memory (not shown). The system 1200 may operate in accordance with the flowcharts in FIGS. 7-10, as well.

As mentioned above, in other examples of embodiments of the invention, systems and methods described herein may be used to multicast multimedia content to multiple devices. For example, a provider of multimedia services, including the distribution of videos, may use methods described herein to distribute videos via the Internet to devices used by subscribers of the service. In one example, a service provider maintains a server computer to multicast one or more videos cyclically and repeatedly via respective channels over the Internet. A subscriber to the service maintains a subscriber device, which may comprise a cable set-top box, for example, in his or her home. The subscriber device communicates with the server computer via the Internet. A subscriber wishing to download a particular movie video uses an interactive program guide or similar application residing on the subscriber device to select the desired movie from a list of movies available from the service provider, and directs the device to download the desired movie. The subscriber device submits a request for the desired video to the server computer, which transmits a message to the device specifying a channel on which the desired movie video is being transmitted. The device, in response, begins to receive the movie video via the specified channel. Because the transmission is cyclical, the device can begin to receive the video data at any time, such as during periods of low usage. If the device begins to receive the video data in the “middle” of the movie, the device receives data until the “end” of the movie and then continues to receive data until the entire video file has been received. The movie video is stored in the device's memory, and the subscriber can watch the movie video at his or her convenience.

The foregoing merely illustrates the principles of the invention. It will thus be appreciated that those skilled in the art will be able to devise numerous other arrangements which embody the principles of the invention and are thus within its spirit and scope.

We claim:

1. A method to transmit data to one or more devices, comprising:
transmitting one or more data files cyclically via one or more respective channels;
receiving from a device a request for at least one desired data file; and
transmitting to the device a message identifying a respective channel associated with the at least one desired data file.

2. The method of claim 1, comprising:
transmitting the at least one desired data file cyclically via at least one selected channel.

3. The method of claim 2, wherein the at least one desired data file comprises one or more software applications.

4. The method of claim 3, wherein the one or more software applications comprise at least a first version of a selected software application, the first version being suitable for a first type of device, and a second version of the software application, the second version being suitable for a second type of device.

5. The method of claim 3, wherein the one or more software applications comprise at least one operating system.

6. The method of claim 5, wherein the at least one selected channel comprise at least one radio-frequency channel.

7. The method of claim 6, wherein the device comprises at least one device chosen from a group consisting of: a personal computer, a laptop computer, a Blackberry device, a cell phone, a personal digital assistant, and a game console.

8. The method of claim 7, wherein the request comprises an identifier of the device, the method further comprising:
selecting the one or more software applications based, at least in part, on the identifier.

9. The method of claim 8, further comprising:
defining at least two partitions within the at least one desired data file;
generating a second data file comprising the at least two partitions and address information indicating at least one memory address associated with each respective partition and indicating where the respective partition is to be stored in the device;
compressing the second data file;
converting the compressed second data file into a set of data packets; and
transmitting the set of data packets cyclically via the at least one selected channel.

10. The method of claim 8, comprising:
compressing the one or more software applications.

11. The method of claim 8, wherein the message further comprises second information indicating a number of data packets associated with the at least one desired data file.

12. The method of claim 1, wherein the one or more respective channels comprise at least one channel chosen from a group consisting of: a radio-frequency channel and an Internet channel.

13. The method of claim 1, further comprising:
transmitting a second data file cyclically via a second channel different from the at least one selected channel;
receiving from a second device a second request for the second data file; and
transmitting to the second device a second message identifying the second channel.

14. The method of claim 1, further comprising:
communicating with the device via a cable connection; and
transmitting the one or more data files cyclically via one or more respective channels over the cable connection.

15. A method to receive data via a communication channel, comprising:
receiving, by a device, software configured to manage the downloading of one or more data files;
storing, by the device, the software in a memory;
transmitting, by the device, a request for at least one desired data file, under control of the software;
receiving, by the device, a message specifying a channel associated with the at least one desired data file;
accessing the channel, in response to the message;
receiving, via the channel, a first portion of the at least one desired data file during a first transmission cycle;
receiving, via the channel, a second portion of the at least one desired data file during a second transmission cycle; and
assembling the at least one desired data file based, at least in part, on the first and second portions.

16. The method of claim 15, wherein the at least one desired data file comprises one or more software applications.

17. The method of claim 16, wherein the one or more software applications comprise at least one operating system.

18. The method of claim 17, wherein the specified channel comprises at least one radio-frequency channel.

19. The method of claim 18, wherein the device comprises at least one device chosen from a group consisting of: a personal computer, a laptop computer, a Blackberry device, a cell phone, a personal digital assistant, and a game console.

20. The method of claim 19, wherein the at least one desired data file is compressed, the method further comprising:
decompressing the at least one desired data file, by the device.

21. The method of claim 19, wherein the at least one desired data file is partitioned and compressed, the method further comprising:
tuning to the channel;
receiving a set of data packets via the channel;
assembling the set of data packets into a first data file;
decompressing the first file, to generate a second data file;
retrieving, from the second data file, at least two partitions associated with the at least one desired data file and address information indicating one or more memory addresses associated with the respective partitions; and
storing the at least two partitions in a storage in the device, based on the address information.

22. The method of claim 21, wherein the message further comprises second information indicating a number of data packets associated with at least one desired data file.

23. The method of claim 21, wherein the assembling, decompressing, retrieving, and storing are performed under control of the software.

24. The method of claim 21, wherein:
the at least one desired data file is transmitted cyclically via the specified channel in multiple transmission cycles.

25. The method of claim 24, comprising:
receiving first data packets starting from an intermediate data packet of the at least one desired data file until a final data packet of the at least one desired data file;
receiving, after receiving the final data packet, second data packets starting from a first data packet of the at least one desired data file at least up to the intermediate data packet; and
assembling the at least one desired data file based, at least in part, on the first and second data packets.

26. The method of claim 24, further comprising:
receiving, during at least one first transmission cycle, a plurality of first data packets associated with the at least one desired data file;
determining that one or more second data packets associated with the at least one desired data file were not received;
receiving, during at least one second transmission cycle occurring after the at least one first transmission cycle, the one or more second data packets; and
assembling the at least one desired data file based, at least in part, on the plurality of first data packets and the one or more second data packets.

27. The method of claim 15, wherein the channel comprises at least one channel chosen from a group consisting of: a radio-frequency channel and an Internet channel.

28. The method of claim 15, further comprising:
generating the request by the received software.

29. A method to install software onto one or more devices assembled in a manufacturing facility, via a communication channel, the method comprising:
transmitting software cyclically via at least one channel accessible from within a manufacturing facility;
automatically accessing the at least channel, by at least one assembled device, in the manufacturing facility;
receiving the software via the at least one channel, by the at least one assembled device; and
storing the software in at least one memory, by the at least one assembled device.

30. The method of claim 29, wherein the software comprises an operating system.

31. The method of claim 29, comprising:
transmitting the software cyclically via the at least one channel available from within the manufacturing facility, by a second device in the manufacturing facility.

32. The method of claim 31, further comprising:
transmitting, by the at least one assembled device to the second device, at least one request for the software; and
receiving, by the at least one assembled device, at least one message specifying one of the at least one channel.

33. The method of claim 32, wherein the at least one channel comprises at least one radio-frequency channel.

34. The method of claim 33, wherein the at least one assembled device comprises at least one device chosen from a group consisting of: a personal computer, a laptop computer, a Blackberry device, a cell phone, a personal digital assistant, and a game console.

35. The method of claim 29, wherein the at least one assembled device comprises a plurality of devices.

36. The method of claim 29, further comprising:
removing the at least one assembled device from the manufacturing facility, after the software is stored in the at least one memory.

37. The method of claim 36, further comprising:
placing at least one additional assembled device in a location within the manufacturing facility that enables the at least one additional assembled device to access the at least one channel.

38. The method of claim 37, further comprising:
automatically accessing a selected one of the at least one channel, by the at least one additional assembled device, in the manufacturing facility;
receiving the software via the selected channel, by the at least one additional assembled device; and
storing the software in at least one additionally memory, by the at least one additional assembled device.

39. The method of claim 38, further comprising:
removing the at least one additional assembled device from the manufacturing facility, after the software is stored in the at least one additional memory.

40. The method of claim 39, wherein:
the at least one assembled device is assembled within the manufacturing facility.

41. The method of claim 40, wherein:
the at least one additional assembled device is assembled within the manufacturing facility.

42. A system to transmit data to one or more devices, comprising:
at least one first processor configured to:
transmit one or more data files cyclically via one or more respective channels; and
at least one second processor configured to:
receive from a device a request for at least one desired data file; and
transmit to the device a message identifying a respective channel associated with the at least one desired data file.

43. The system of claim 42, wherein the at least one first processor is configured to:
transmit the at least one desired data file cyclically via at least one selected channel.

44. The system of claim 43, wherein:
the at least one desired data file comprises one or more software applications; and
the at least one second processor is configured to:
receive from the device a request for the one or more software applications; and
transmit to the device a message identifying a respective channel associated with the one or more software applications.

45. The system of claim 44, wherein:
the one or more software applications comprise at least a first version of a selected software application, the first version being suitable for a first type of device, and a second version of the software application, the second version being suitable for a second type of device;
the at least one first processor is configured to:
transmit the first version via a first channel; and
transmit the second version via a second channel; and
the at least one second processor is configured to:
receive from a first device a request for the first version; and
transmit to the first device a message identifying the first channel;
the at least one second processor being further configured to:
receive from a second device a request for the second version; and
transmit to the second device a message identifying the second channel.

46. The system of claim 44, wherein the one or more software applications comprise at least one operating system.

47. The system of claim 44, wherein the at least one selected channel comprises at least one radio-frequency channel.

48. The system of claim 47, wherein the device comprises at least one device chosen from a group consisting of: a personal computer, a laptop computer, a Blackberry device, a cell phone, a personal digital assistant, and a game console.

49. The system of claim 48, wherein the request comprises an identifier of the device,
the at least one second processor being further configured to:
select the one or more software applications based, at least in part, on the identifier.

50. The system of claim 49, wherein the at least one first processor is further configured to:
define at least two partitions within the at least one desired data file;
generate a second data file comprising the at least two partitions and address information indicating at least one memory address associated with each respective partition and indicating where the respective partition is to be stored in the device;
compress the second data file;
convert the compressed second data file into a set of data packets; and
transmit the set of data packets cyclically via the at least one selected channel.

51. The system of claim 49, wherein the at least one first processor is further configured to:
compress the at least one desired data file.

52. The system of claim 49, wherein the message further comprises second information indicating a number of data packets associated with the set of data packets.

53. The system of claim 42, wherein the one or more respective channels comprise at least one channel chosen from a group consisting of: a radio-frequency channel and an Internet channel.

54. The system of claim 42, wherein the at least one first processor is further configured to:
transmit a second data file cyclically via a second channel different from the at least one selected channel;
the at least one second processor being further configured to:
receive from a second device a second request for the second data file; and
transmit to the second device a second message identifying the second channel.

55. The system of claim 42, wherein the at least one first processor is configured to:
transmit one or more data files cyclically via one or more respective channels via a cable connection.

56. A device to receive data via a communication channel, comprising:
at least one memory configured to store data; and
at least one processor configured to:
receive software configured to manage the downloading of one or more data files;
store the software in the memory;
transmit a request for at least one desired data file, under control of the software;
receive a message specifying a channel associated with the at least one desired data file;
access the channel, in response to the message;
receive, via the channel, a first portion of the at least one desired data file during a first transmission cycle;
receive, via the channel, a second portion of the at least one desired data file during a second transmission cycle; and
assemble the at least one desired data file based, at least in part, on the first and second portions.

57. The device of claim 56, wherein the at least one desired data file comprises one or more software applications.

58. The device of claim 57, wherein the one or more software applications comprise at least one operating system.

59. The device of claim 58, wherein the specified channel comprises at least one radio-frequency channel.

60. The device of claim 59, wherein:
the device is chosen from a group consisting of: a personal computer, a laptop computer, a Blackberry device, a cell phone, a personal digital assistant, and a game console.

61. The device of claim 60, wherein the at least one desired data file is compressed, and the at least one processor is further configured to:
decompress the at least one desired data file.

62. The device of claim 60, wherein at least one desired data file is partitioned and compressed, the at least one processor being configured to:
tune to the channel;
receive a set of data packets via the channel;
assemble the set of data packets into a first data file;
decompress the first file, generating a second data file;
retrieve, from the second data file, at least two partitions associated with the at least one desired data file and address information indicating one or more memory addresses associated with the respective partitions; and
store the at least two partitions in the memory, based on the address information.

63. The device of claim 62, wherein the message further comprises second information indicating a number of data packets associated with at least one desired data file.

64. The device of claim 63, wherein the at least one processor is further configured to:
receive first data packets starting from an intermediate data packet of the at least one desired data file until a final data packet of the at least one desired data file;
receive, after receiving the final data packet, second data packets starting from a first data packet of the at least one desired data file at least up to the intermediate data packet; and
assemble the at least one desired data file based, at least in part, on the first and second data packets.

65. The device of claim 63, wherein the at least one processor is further configured to:
receive, during at least one first transmission cycle, a plurality of first data packets associated with the at least one desired data file;
determine that one or more second data packets associated with the at least one desired data file were not received;
receive, during at least one second transmission cycle occurring after the at least one first transmission cycle, the one or more second data packets; and
assemble the at least one desired data file based, at least in part, on the plurality of first data packets and the one or more second data packets.

66. The device of claim 56, wherein the channel comprises at least one channel chosen from a group consisting of: a radio-frequency channel and an Internet channel.

67. The device of claim 56, wherein the at least one processor is configured to:
generate the request under control of the received software.

68. The device of claim 56, wherein the at least one processor is configured to:
transmit the request for at least one desired data file to a computer in a manufacturing facility.

69. A system to install software onto one or more devices assembled in a manufacturing facility, via a communication channel, the system comprising:
at least one first processor located in a manufacturing facility, the at least one first processor configured to:
transmit software cyclically via at least one channel accessible from within a manufacturing facility; and
at least one assembled device located in the manufacturing facility, configured to:
automatically access the at least one channel;
receive the software via the at least one channel; and
store the software in at least one memory.

70. The system of claim 69, wherein the software comprises an operating system.

71. The system of claim 70, wherein the at least one assembled device is further configured to:
transmit to the at least one first processor at least one request for the software; and
receive at least one message specifying one of the at least one channel.

72. The system of claim 71, wherein the at least one channel comprises at least one radio-frequency channel.

73. The system of claim 72, wherein the at least one assembled device comprises at least one device chosen from a group consisting of: a personal computer, a laptop computer, a Blackberry device, a cell phone, a personal digital assistant, and a game console.

74. The system of claim 69, wherein:
the at least one assembled device comprises a plurality of assembled devices.

75. The system of claim 74, wherein:
the at least one assembled device is removed from the manufacturing facility, after the software is stored in a memory of the at least one selected device.

76. The system of claim 75, further comprising:
at least one additional assembled device placed in a location within the manufacturing facility that enables the at least one additional assembled device to access the at least one channel.

77. The system of claim 76, wherein the at least one additional assembled device is further configured to:
automatically access a selected one of the at least one channel, in the manufacturing facility;
receive the software via the selected channel; and
store the software in at least one additionally memory;
wherein:
the at least one additional assembled device is removed from the manufacturing facility, after the software is stored in the at least one additional memory.

78. The system of claim 75, wherein:
the at least one assembled device is assembled within the manufacturing facility.
